(19) United States
(12) Patent Application Publication
(10) Pub. No.: US 2008/0245834 A1
(43) Pub. Date: Oct. 9, 2008

(54) COLLAPSIBLE STORAGE SYSTEM

(76) Inventors: William M. Abramczyk, Rochester Hills, MI (US); Jeffrey Singer, Canton, MI (US)

Correspondence Address: DYKEMA GOSSETT PLLC, Third Floor West, Franklin Square, 1300 I Street NW, Washington, DC, 20005-3353, US

(21) Appl. No.: 11/697,951

(22) Filed: Apr. 9, 2007

(51) Int. Cl. B60R 9/00

(52) U.S. Cl. 224/539; 220/666

(57) ABSTRACT

A collapsible storage system attachable to an exterior or an interior of an automobile. The storage system may include a front primary panel pivotally connected to a central primary panel at one end of the central primary panel, and a rear primary panel pivotally connected to the central primary panel at an opposite end of the central primary panel. The front, rear and/or central primary panels may include pivotally connected secondary side panels. The front and rear primary panels may be pivotally movable relative to the central primary panel and the secondary side panels may be pivotally movable laterally relative to the front, rear and/or central primary panels in predetermined directions to place the storage system in an assembled configuration, and may be movable in predetermined opposite directions to place the storage system in a collapsed configuration.

### BACKGROUND OF INVENTION

a. Field of Invention

The invention relates generally to storage systems for use with automobiles and the like, and more particularly, to a collapsible storage system for use as an exterior or interior storage compartment with an automobile.

b. Description of Related Art

As is known in the art, a variety of storage devices are available for use as an exterior or interior supplemental storage compartment with an automobile. When used on the exterior of an automobile, such devices, while functioning as a storage compartment, must also be designed to withstand the forces and wear associated with automobile movement and other environmental factors. Such devices must also be lightweight for facilitating attachment and removal thereof, yet rigid enough for properly securing objects therein. Yet further, it is beneficial for such devices to be foldable and/or detachable into sub-components for facilitating the storage thereof.

When used in an interior of an automobile, such storage devices must generally meet the aforementioned design and performance requirements for exterior storage devices, and must also be readily attachable to an automobile interior component without requiring significant design modifications to an automobile interior.

Exemplary storage devices, such as the ones disclosed in U.S. Pat. No. 2,069,345 to Widman, U.S. Pat. No. 4,201,413 to Rowe, U.S. Pat. No. 4,362,258 to French, U.S. Pat. No. 6,772,926 to Eichele, and U.S. Pat. No. 7,090,286 to Foreth provide for increased storage in the interior or exterior of an automobile. For example, the trunk compartment illustrated in FIG. 1 of Widman provides for a variable space storage device mountable as or adjacent the trunk of an automobile. As readily evident, the Widman trunk compartment is limited to its fixed arrangement illustrated in FIG. 1, and is therefore not readily removable or adaptable for use in the interior of an automobile.

Compared to the Widman trunk compartment, the camper top type storage devices of Rowe, French and Foreth provide various alternatives for increased storage in a truck-mounted camper. These devices, in particular the French and Foreth camper lift systems as respectively illustrated in FIGS. 3 and 1 thereof, include several mechanically operated rods and linkages for facilitating the lift function. As readily evident, the mechanically operated rods and linkages not only significantly complicate the design and operation of these storage devices, these components also render the French and Foreth storage devices readily susceptible to defects and/or breakdown. Moreover, as with the Widman trunk compartment, the Rowe, French and Foreth storage devices are limited to their fixed arrangement illustrated and are therefore not readily removable or adaptable for use in the interior of an automobile.

Yet further, compared to the Widman, Rowe, French and Foreth storage devices, the Eichele vehicle roof mounted carrier, as illustrated in FIGS. 1-7 thereof, includes a retractable carrier system (10) having an upper web (22) connectable to lower web (28) by a zipper. Whereas the Eichele roof mounted carrier is simpler in operation and includes fewer components than the Widman, Rowe, French and Foreth storage devices, the Eichele roof mounted carrier provides virtually no security for objects stored therein due to its soft rollable construction. Moreover, in use, the Eichele roof mounted carrier can be a source of excessive wind noise due to its soft construction.

It is therefore desirable to provide a vehicle storage device which is readily adaptable for use as an exterior or interior supplemental storage compartment, and which is capable of withstanding the forces and wear associated with automobile movement and other environmental factors. It is also desirable to provide a vehicle storage device which is lightweight yet rigid in construction for facilitating attachment and removal thereof, and for adequate protection of objects stored therein, and which is foldable and/or detachable into sub-components for facilitating the storage thereof.

### SUMMARY OF THE INVENTION

The invention solves the problems and overcomes the drawbacks and deficiencies of prior art vehicle storage devices by providing a collapsible storage system attachable to an exterior or an interior of an automobile. The storage system may include a front primary panel pivotally connected to a central primary panel at one end of the central primary panel, and a rear primary panel pivotally connected to the central primary panel at an opposite end of the central primary panel. The front, rear and/or central primary panels may include pivotally connected secondary side panels. The front and rear primary panels may be pivotally movable relative to the central primary panel and the secondary side panels may be pivotally movable laterally relative to the front, rear and/or central primary panels in predetermined directions to place the storage system in an assembled configuration. Further, the front and rear primary panels may be pivotally movable relative to the central primary panel and the secondary side panels may be pivotally movable laterally relative to the front, rear and/or central primary panels in predetermined opposite directions to place the storage system in a collapsed configuration.

For the collapsible storage system described above, the secondary side panels may be pivotally connected to the central primary panel. The front primary panel may include a pivotally connected front sub-panel, and the front primary panel and the front sub-panel may be pivotally movable about generally parallel pivot axis. The rear primary panel may include one or more pivotally connected rear sub-panels, and the rear primary panel and the rear sub-panel may be pivotally movable about generally parallel pivot axis. The rear primary panel may include one or more lateral sub-panels pivotally moveable for engagement with a respective one of the secondary side panels. The lateral sub-panel may be engageable with a respective one of the secondary side panels by complementary VELCRO strips provided on the lateral sub-panel and the secondary side panel. The secondary side panels may include transversely disposed sub-panels which are pivotally moveable for engagement with the front primary panel whereby when the storage system is disposed in the assembled configuration the front primary panel is disposed at an acute angle relative to the central primary panel. The transversely disposed sub-panels may be engageable with the front primary panel by complementary VELCRO strips provided on the transversely disposed sub-panels and the front primary panel. The storage system may be attachable to a roof or trunk of an automobile for use as a collapsible exterior mounted storage system. The storage system may also be attachable to an interior component of an automobile for use as a collapsible interior mounted storage system. Further, the storage system may include a mount for attachment of a secondary storage device.

The invention also provides a collapsible storage system including a front primary panel pivotally connected to a central primary panel at one location of the central primary panel, and a rear primary panel pivotally connected to the central primary panel at a second generally opposite location of the central primary panel. The front, rear and/or central primary panels may include pivotally connected secondary side panels. The front and rear primary panels may be pivotally movable relative to the central primary panel and the secondary side panels may be pivotally movable laterally relative to the front, rear and/or central primary panels in predetermined directions to place the storage system in an assembled configuration. Further, the front and rear primary panels may be pivotally movable relative to the central primary panel and the secondary side panels may be pivotally movable laterally relative to the front, rear and/or central primary panels in predetermined opposite directions to place the storage system in a collapsed configuration.

For the collapsible storage system described above, the secondary side panels may be pivotally connected to the central primary panel. The front primary panel may include a pivotally connected front sub-panel, and the front primary panel and the front sub-panel may be pivotally movable about generally parallel pivot axis. The rear primary panel may include one or more pivotally connected rear sub-panels, and the rear primary panel and the rear sub-panel may be pivotally movable about generally parallel pivot axis. The rear primary panel may include one or more lateral sub-panels pivotally moveable for engagement with a respective one of the secondary side panels. The lateral sub-panel may be engageable with a respective one of the secondary side panels by complementary VELCRO strips provided on the lateral sub-panel and the secondary side panel. The secondary side panels may include transversely disposed sub-panels which are pivotally moveable for engagement with the front primary panel whereby when the storage system is disposed in the assembled configuration the front primary panel is disposed at an acute angle relative to the central primary panel. The transversely disposed sub-panels may be engageable with the front primary panel by complementary VELCRO strips provided on the transversely disposed sub-panels and the front primary panel. The storage system may be attachable to a roof or trunk of an automobile for use as a collapsible exterior mounted storage system. The storage system may also be attachable to an interior component of an automobile for use as a collapsible interior mounted storage system. Further, the storage system may include a mount for attachment of a secondary storage device.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an isometric view of a collapsible storage system according to the present invention, illustrating the storage system in a collapsed configuration and mounted to an automobile roof;

FIG. 2 is an enlarged isometric view of the collapsible storage system of FIG. 1, illustrating the storage system in a collapsed configuration and mounted to an automobile roof;

FIG. 3 is an isometric view of the collapsible storage system of FIG. 1, illustrating the storage system in an assembled configuration and mounted to an automobile roof;

FIG. 4 is an enlarged isometric view of the collapsible storage system of FIG. 1, illustrating the storage system in an assembled configuration and mounted to an automobile roof;

FIG. 5 is an isometric view of the collapsible storage system of FIG. 1, illustrating the storage system in a collapsed configuration;

FIGS. 6-17 are isometric views of the collapsible storage system of FIG. 1, illustrating exemplary steps and movements of the storage system primary panels and sub-panels for placing the storage system in an assembled configuration;

FIG. 18 is an isometric view of the collapsible storage system of FIG. 1, illustrating the storage system in an assembled configuration;

FIG. 19 is a top view of the collapsible storage system of FIG. 1, including an assembly for facilitating attachment of a bicycle; and

FIG. 20 is a side view of the collapsible storage system of FIG. 1, including the assembly of FIG. 19 including a bicycle mounted thereto.

### DETAILED DESCRIPTION OF THE PREFERRED EMBODIMENTS

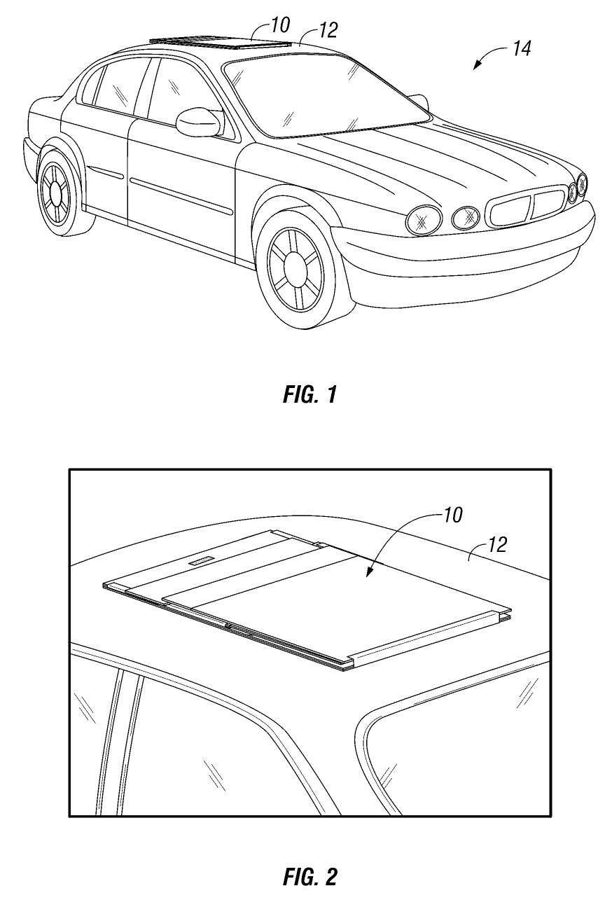

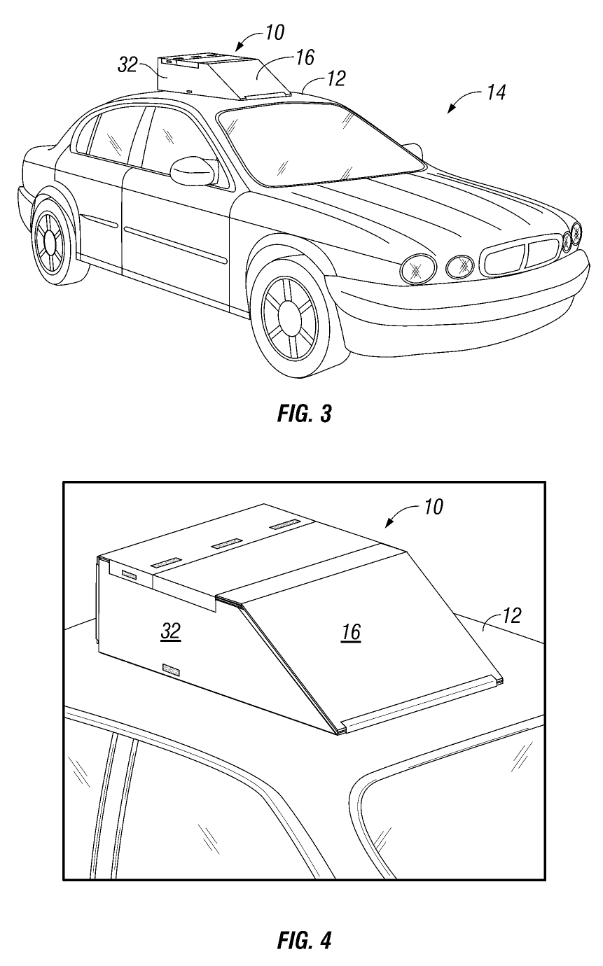

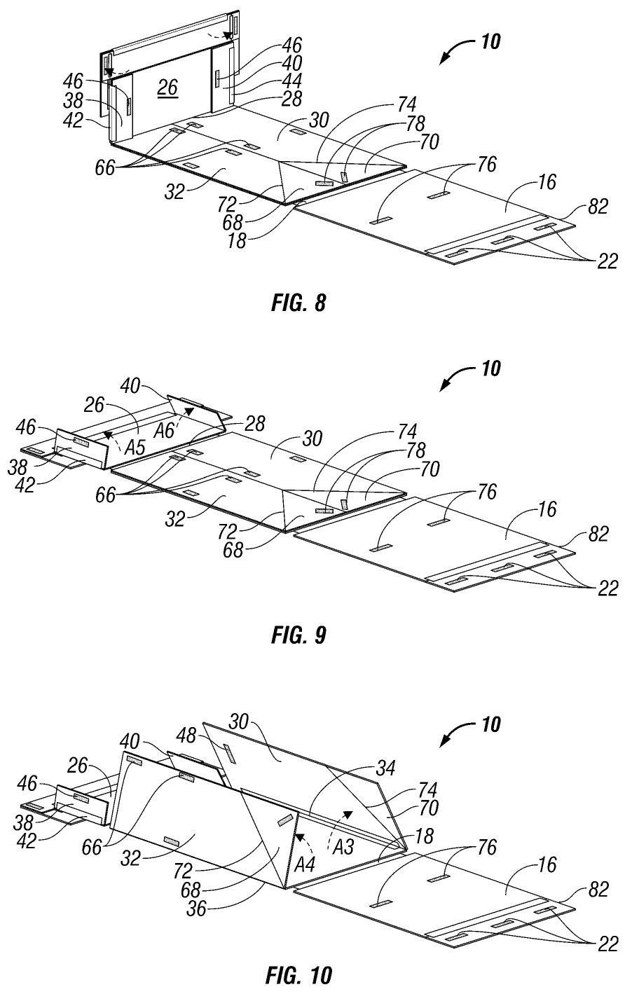

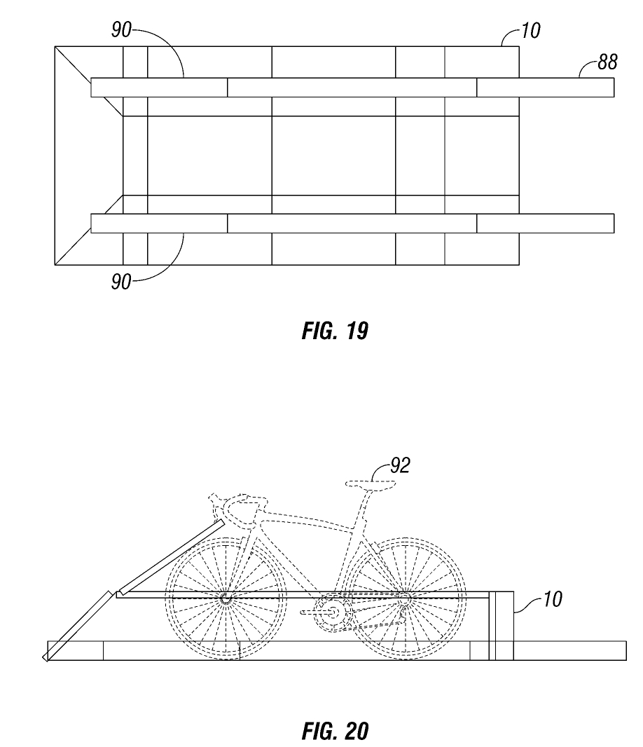

Referring now to the drawings wherein like reference numerals designate corresponding parts throughout the several views, FIGS. 1-18 illustrate various views of a collapsible storage system according to the present invention, generally designated “collapsible storage system 10,” and FIGS. 19 and 20 illustrate an exemplary assembly for facilitating attachment of a bicycle to collapsible storage system 10.

Referring to FIGS. 1-4, collapsible storage system 10 described herein may generally be removably mountable on roof 12 of an automobile 14. As readily evident to those skilled in the art, collapsible storage system 10 may be likewise mountable on the trunk, disposable within automobile 14, or otherwise usable in a home, office or another environment without departing from the scope of the present invention.

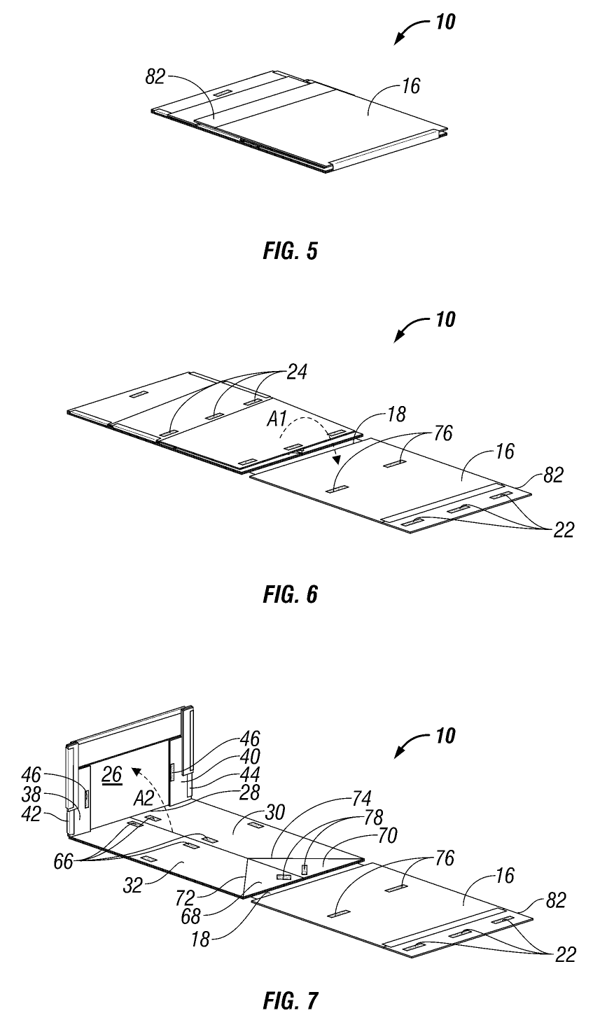

Referring next to FIGS. 5-18, the various primary panels and sub-panels of collapsible storage system 10 will be described in detail. Further, whereas for ease of understanding, the panels and movement thereof will be described with reference to the front, rear, right (passenger side) and left (driver side) orientation of FIGS. 1-4, those skilled in the art would readily appreciate in view of this disclosure that collapsible storage system 10 may be oriented as needed by a user without departing from the scope of the present invention.

Referring to FIG. 5, collapsible storage system 10 is illustrated in its collapsed (or stowed) position. In order to place collapsible storage system 10 in its assembled configuration of FIG. 18, as shown in FIG. 6, front primary panel 16 may be rotated as shown in direction A1 about its pivot connection 18 relative to central primary panel 20 (see FIG. 10), by detachment of complementary VELCRO strips 22, 24, or other attachment means known in the art. As readily evident, VELCRO strips 22, 24 maintain collapsible storage system 10 in its collapsed configuration of FIG. 5. Thereafter, referring to FIGS. 7-9, rear primary panel 26 may be rotated as shown in direction A2 about its pivot connection 28, whereby collapsible storage system 10 is still disposed in a generally flat configuration as illustrated in FIG. 9. Referring to FIG. 10, central primary panel 20 may include left and right side secondary panels 30, 32, which as shown, may be rotated in directions A3, A4 about respective pivot connections 34, 36. At the same time, as shown in FIG. 9, sub-panels 38, 40, provided on rear primary panel 26 may be rotated in directions A5, A6 about respective pivot connections 42, 44.

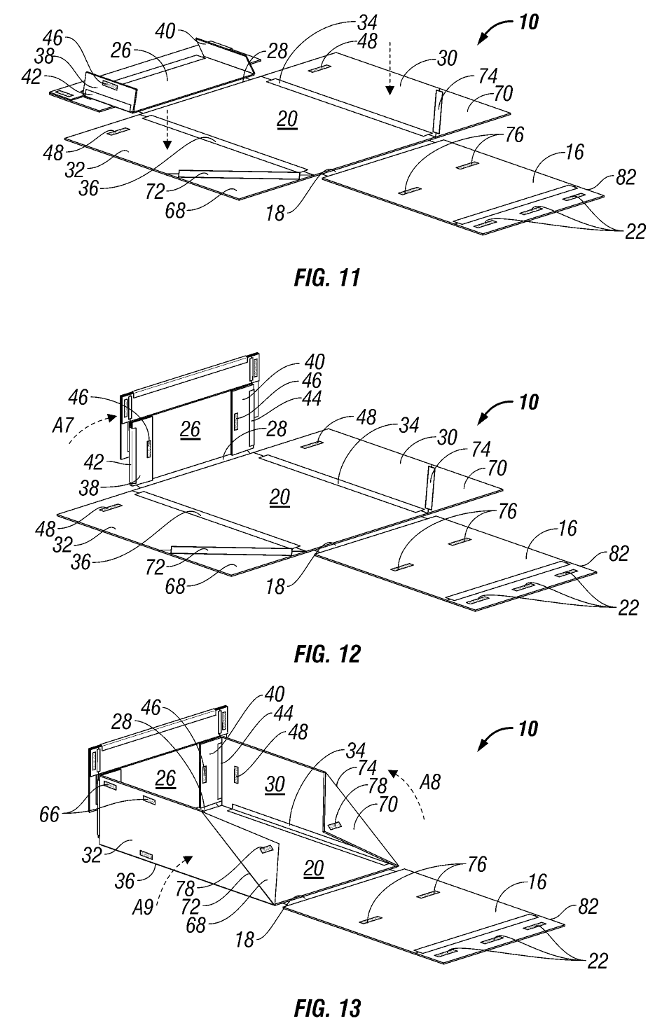

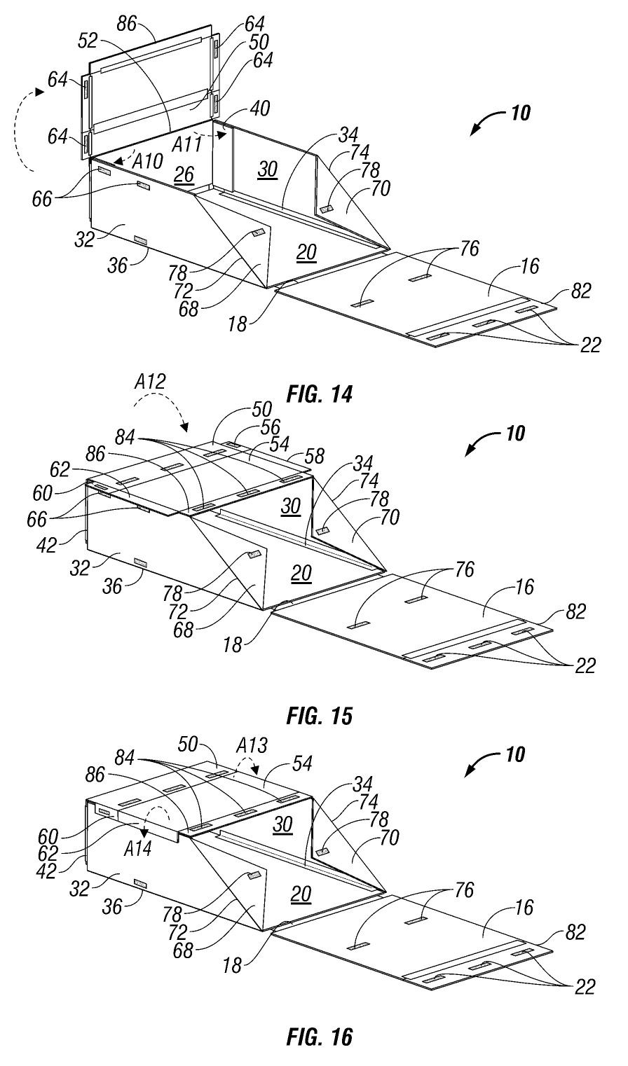

Referring next to FIG. 11, with front and rear primary panels 16, 26, and left and right side secondary panels 30, 32, rotated as discussed above, collapsible storage system 10 may be disposed in the generally flat configuration illustrated. Referring to FIG. 12, rear primary panel 26 may be rotated in direction A7 as shown, and thereafter, as shown in FIG. 13, left and right side secondary panels 30, 32 may be rotated in directions A8, A9 as shown. As shown in FIG. 14, sub-panels 38, 40 may be rotated in directions A10, A11 and respectively connected to right and left side secondary panels 32, 30 by means of complementary VELCRO strips 46, 48 respectively provided on panels 38, 40 and 30, 32. At the same time, as shown in FIGS. 14 and 15, with panels 38, 40 and 32, 30 respectively secured as discussed, rear sub-panel 50 may be rotated about its pivot connection 52 in direction A12, and thereafter, rotation may be continued so that sub-panel 50 and sub-panel 54 are disposed in the generally horizontal configuration of FIG. 15. Thereafter, as shown in FIG. 16, left and right side rear sub-panels 56, 58 and 60, 62 may be folded about their respective pivot connections in directions A13, A14 such that VELCRO strips 64 provided on sub-panels 56, 58, 60 and 62 are engaged with complementary VELCRO strips 66 provided on left and right side secondary panels 30, 32.

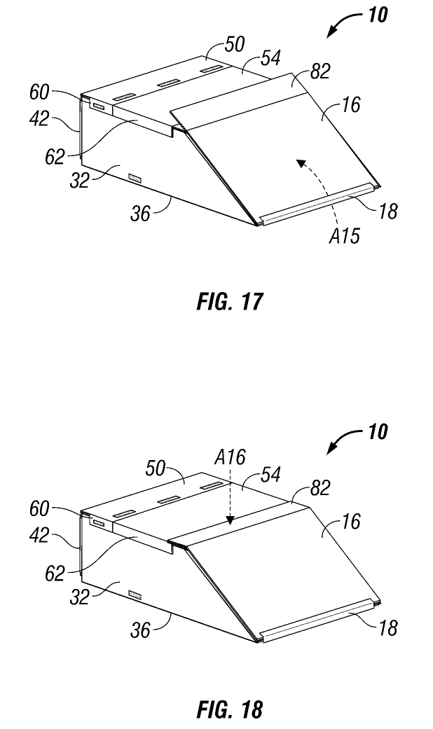

Referring next to FIGS. 13-16, triangular sub-panels 68, 70, respectively provided on right and left side secondary panels 30, 32, may be folded about their respective pivot connections 72, 74 from their configuration of FIG. 12. As shown in FIG. 17, front primary panel 16 may be folded about its pivot connection 18 in direction A15. At this stage, referring to FIG. 16, VELCRO strips 76 provided on front primary panel 16 may be engaged with complementary VELCRO strips 78 provided on triangular sub-panels 68, 70, for connecting panel 16 to sub-panels 68, 70. Lastly, referring to FIG. 18, VELCRO strips 22 provided on front sub-panel 82 may be engaged with complementary VELCRO strips 84 provided on rear sub-panel 86 by pushing front sub-panel 82 in direction A16 as shown for connecting front sub-panel 82 to rear sub-panel 86.

Based on the detailed description above, collapsible storage system 10 may be re-configured from its collapsed (or stowed) configuration of FIG. 5 to its assembled configuration of FIG. 18. As readily evident, in order to place storage system 10 in its collapsed configuration of FIG. 15, the exemplary steps discussed above with reference to FIGS. 5-18 may be reversed in order from FIG. 18 to FIG. 5.

The aforementioned panels and sub-panels of storage system 10 may be made of a plastic or another rigid material. Yet further, the various pivot connections discussed above may be likewise made of a flexible material, or of plastic or metallic hinge connections.

Those skilled in the art would readily appreciate in view of this disclosure that various modifications may be made to collapsible storage system 10 without departing from the scope of the present invention. For example, referring to FIGS. 19 and 20, storage system 10 may be readily adapted for attachment of bicycle carrying accessory 88, as well as other accessories for skis, boats and other such equipment, for use in the system collapsed or assembled configuration (shown). Alternatively, a variety of gaps at 90 may be provided for attachment of a bicycle 92 in a partially concealed manner as illustrated in FIG. 20. Further, whereas the various panels and sub-panels of system 10 are illustrated for manual movement, system 10 may be configured for automatic deployment by means of electric motors, hydraulics or inflatable means. Yet further, a plurality of access doors/panels (not shown) may be provided as needed, particularly on left and right side secondary panels 30, 32 for providing access to the interior of storage system 10. Moreover, collapsible storage system 10 may be connected to the exterior or interior of an automobile by means of, for example, hook/rod type connections provided on central primary panel 20, whereby a hook provided on panel 20 may be connected to a rod (i.e. a storage rack rod or a rod (not shown) attached to the roof of an automobile for the specific purpose of engagement with the hook of storage system 10) provided on automobile 14. Alternatively, a hook provided on panel 20 (or another panel or sub-panel) may be connectable to a complementary rod or another connection provided on an interior component (i.e. a seat) of an automobile for removably attaching system 10 to an interior of an automobile.

To summarize, the invention thus provides a collapsible storage system 10 which is readily adaptable for use as an exterior or interior supplemental storage compartment, and which is capable of withstanding the forces and wear associated with automobile movement and other environmental factors. Storage system 10 is also lightweight yet rigid in construction for facilitating attachment and removal thereof, and for adequate protection of objects stored therein, and is foldable and/or detachable (if needed into sub-components) for facilitating the storage thereof. Moreover, based on the sloped configuration of front primary panel 16 and the sealed configuration of storage system 10 based on the discussion above with reference to FIGS. 5-18, system 10 is readily usable with an automobile.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A collapsible storage system attachable to an exterior or an interior of an automobile, said storage system comprising:
a front primary panel pivotally connected to a central primary panel at one end of said central primary panel;
a rear primary panel pivotally connected to said central primary panel at an opposite end of said central primary panel; and
at least one of said front, rear and central primary panels including pivotally connected secondary side panels,
wherein said front and rear primary panels are pivotally movable relative to said central primary panel and said secondary side panels are pivotally movable laterally relative to at least one of said front, rear and central primary panels in predetermined directions to place said storage system in an assembled configuration, and wherein said front and rear primary panels are pivotally movable relative to said central primary panel and said secondary side panels are pivotally movable laterally relative to at least one of said front, rear and central primary panels in predetermined opposite directions to place said storage system in a collapsed configuration.

2. A collapsible storage system according to claim 1, wherein said secondary side panels are pivotally connected to said central primary panel.

3. A collapsible storage system according to claim 1, wherein said front primary panel includes a pivotally connected front sub-panel, said front primary panel and said front sub-panel are pivotally movable about generally parallel pivot axis.

4. A collapsible storage system according to claim 3, wherein said rear primary panel includes at least one pivotally connected rear sub-panel, said rear primary panel and said rear sub-panel are pivotally movable about generally parallel pivot axis.

5. A collapsible storage system according to claim 1, wherein rear primary panel includes at least one lateral sub-panel pivotally moveable for engagement with a respective one of said secondary side panels.

6. A collapsible storage system according to claim 5, wherein said lateral sub-panel is engageable with a respective one of said secondary side panels by complementary VELCRO strips provided on said lateral sub-panel and said secondary side panel.

7. A collapsible storage system according to claim 1, wherein said secondary side panels include transversely disposed sub-panels which are pivotally moveable for engagement with said front primary panel whereby when said storage system is disposed in said assembled configuration said front primary panel is disposed at an acute angle relative to said central primary panel.

8. A collapsible storage system according to claim 7, wherein said transversely disposed sub-panels are engageable with said front primary panel by complementary VELCRO strips provided on said transversely disposed sub-panels and said front primary panel.

9. A collapsible storage system according to claim 1, wherein said storage system is attachable to one of a roof and a trunk of an automobile for use as a collapsible exterior mounted storage system.

10. A collapsible storage system according to claim 1, wherein said storage system is attachable to an interior component of an automobile for use as a collapsible interior mounted storage system.

11. A collapsible storage system according to claim 1, wherein said storage system further includes a mount for attachment of a secondary storage device.

12. A collapsible storage system comprising:
a front primary panel pivotally connected to a central primary panel at one location of said central primary panel;
a rear primary panel pivotally connected to said central primary panel at a second generally opposite location of said central primary panel; and
at least one of said front, rear and central primary panels including pivotally connected secondary side panels,
wherein said front and rear primary panels are pivotally movable relative to said central primary panel and said secondary side panels are pivotally movable laterally relative to at least one of said front, rear and central primary panels in predetermined directions to place said storage system in an assembled configuration, and wherein said front and rear primary panels are pivotally movable relative to said central primary panel and said secondary side panels are pivotally movable laterally relative to at least one of said front, rear and central primary panels in predetermined opposite directions to place said storage system in a collapsed configuration.

13. A collapsible storage system according to claim 11, wherein said secondary side panels are pivotally connected to said central primary panel.

14. A collapsible storage system according to claim 11, wherein said front primary panel includes a pivotally connected front sub-panel, said front primary panel and said front sub-panel are pivotally movable about generally parallel pivot axis.

15. A collapsible storage system according to claim 14, wherein said rear primary panel includes at least one pivotally connected rear sub-panel, said rear primary panel and said rear sub-panel are pivotally movable about generally parallel pivot axis.

16. A collapsible storage system according to claim 11, wherein said rear primary panel includes at least one lateral sub-panel pivotally moveable for engagement with a respective one of said secondary side panels.

17. A collapsible storage system according to claim 16, wherein said lateral sub-panel is engageable with a respective one of said secondary side panels by complementary VELCRO strips provided on said lateral sub-panel and said secondary side panel.

18. A collapsible storage system according to claim 11, wherein said secondary side panels include transversely disposed sub-panels which are pivotally moveable for engagement with said front primary panel whereby when said storage system is disposed in said assembled configuration said front primary panel is disposed at an acute angle relative to said central primary panel.

19. A collapsible storage system according to claim 18, wherein said transversely disposed sub-panels are engageable with said front primary panel by complementary VELCRO strips provided on said transversely disposed sub-panels and said front primary panel.

20. A collapsible storage system according to claim 11, wherein said storage system is attachable to one of a roof and a trunk of an automobile for use as a collapsible exterior mounted storage system.
